(19) United States
(12) Patent Application Publication
(10) Pub. No.: US 2007/0162578 A1
(43) Pub. Date: Jul. 12, 2007

(54) System and method for application initiated user interaction

(75) Inventors: Kumar Bhaskaran, Englewood Cliffs, NJ (US); Badrish Chandramouli, Durham, NC (US); Hung-Yang Chang, Scarsdale, NY (US); Hui Lei, Scarsdale, NY (US)

Correspondence Address: Steven Fischman, Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 11/328,027

(22) Filed: Jan. 9, 2006

(51) Int. Cl. G06F 15/173

(52) U.S. Cl. 709/223

(57) ABSTRACT

A system, method and computer program product of using peer collaboration tools to extend the reach of applications by enabling the application to specify a modality policy that is predicated on end-user context when pushing an interaction to the end-user. Various collaboration technologies—including cell phones, email, instant messaging (IM), the short message service (SMS), and pagers—have emerged that people can use to interact with each other even when they are remote and/or mobile. Using collaboration tools as the interface to Web applications eliminates the applications' dependency on Web browsers and allows applications to be accessed even when a Web browser is not available. In addition, collaboration tools are capable of receiving “calls”, which can be exploited by applications to proactively initiate and push an interaction to end users.

### BACKGROUND OF THE INVENTION

1. Field of the Invention

The present invention relates generally to the field of network/web-based applications capable of interacting with many users from a variety of client devices and, particularly, a system and method utilizing on-line collaboration applications and web browsers for enabling application initiated user interactions.

2. Discussion of the Prior Art

Traditionally user interactions with applications are initiated by end users. Although this kind of interaction model is appropriate for applications with a short duration, it is not suitable for long-running applications that can last days or even longer. Examples of such long-running applications include many business processes, activity management, monitoring and surveillance. Constant user presence in these applications is typically not necessary; neither is it feasible. User involvement is needed only when certain events happen and/or when the application state satisfies a pre-defined condition. With a pull approach, the burden is placed on the user to periodically poll the application for the purpose of determining whether her participation is required. Needless to say, such an approach can be very inefficient and may cause critical opportunity loss. In comparison, a push-based approach allows the application to engage a user at the right time by proactively pushing an interaction session to the user. This can substantially reduce the demand for user attention and in the meantime promises to improve the efficiency of the application.

However, simply pushing a notification message may not be adequate. Some applications compensate the limitations of a pull approach by sending users a one-way message on demand. The users can then start an interaction session with the application, from a client browser. In this case, the users have to make an extra effort to switch from a messaging mechanism to a browser. Still, there is no guarantee that a browser is immediately available at the time the notification message is received.

Intended to integrate multiple collaboration modalities, the system must decide which of the collaboration modalities should be used to push the interaction to. As people move from place to place, their connectivity and accessibility to various collaboration tools may change. Depending on the circumstance, some types of tools may also be more preferable than others. For example, if the user is in a meeting, he may not want to receive any phone calls. When he is giving a presentation, he may not want to be interrupted by any instant messages. Generally, the best means of engaging a particular person at a particular moment depends on the person's current context, such as the person's location, activity, connectivity and personal preferences.

Thus, it would be highly desirable to provide a novel approach for enabling on-line applications to contact and initiate interaction with users.

It would further be highly desirable to provide a novel approach for enabling on-line applications to contact and initiate interaction with users in a manner that is sensitive to end-user context and end-user connectivity.

It would further be highly desirable to provide a system and method that enables an application, when pushing an interaction with a user, to select the most appropriate device associated with a user in a manner predicated on user context.

### SUMMARY OF THE INVENTION

In one aspect, the present invention is directed to a system, method and computer program product for web-based applications that enables an application to push an interaction with the end-user. The system, method and computer program product additionally enables the application to specify a modality policy for initiating interaction with the user that is predicated on end-user context. Moreover, according to another aspect of the invention, different modality policies can be used in different places of the application for different interactions, reflecting the needs of the application itself.

Preferably, the system, method and computer program product employs various Modality Agents to mediate between application servers and collaboration clients and web browsers. The Modality Agents interpret User Interface (UI) specifications obtained from the application and render them in a modality-appropriate fashion. They also serve as the initial point of contact for application-initiated interactions. Observing that the choice of an appropriate user interaction modality depends on the user's current context, the system and method also provides for client selection policies that are predicated on dynamic user context information such as location, activity and connectivity.

Thus, according to the invention, there is provided a system, method and computer program for enabling modality-independent interaction between a web-based application and a user in web-based environment via a variety of client devices. The method comprises:
providing a push means responsive to said application for initiating interaction with a user via a client device of a determined modality; and,
providing a modality agent means associated with the determined modality for enabling users to interact with the application via the client device.

Advantageously, the system and method of the invention eliminates a web-based application's dependency on Web browsers and allows applications to be accessed even when a Web browser is not available

### BRIEF DESCRIPTION OF THE DRAWINGS

The objects, features and advantages of the present invention will become apparent to one skilled in the art, in view of the following detailed description taken in combination with the attached drawings, in which:

FIG. 1 is a diagram depicting the system 10 of the present invention;

FIG. 2 depicts an architecture for implementing modality agents according to one embodiment of the invention;

FIG. 3 depicts a system architecture 100 for implementing the Pusher 70 according to one embodiment of the invention

FIG. 4 provides an illustrative example of the sequence 200 of a user-initiated interaction according to one embodiment of the invention;

FIG. 5 provides an illustrative example of the sequence 250 of an application-initiated interaction according to one embodiment of the invention; and,

FIG. 6 depicts an example implementation of the invention.

### DETAILED DESCRIPTION OF PREFERRED EMBODIMENT

The present invention is directed to a system, method and computer program product provides a Web application extension framework providing pervasive access to Web applications from a wide range of clients, including both Web browsers and collaboration tools. In addition to user initiated, or pull-based, interactions, the system allows an application to proactively push an interaction to a user, in a manner sensitive to the application's needs and the user's current context. The system employs various Modality Agents to mediate between application servers and collaboration clients and web browsers. The Modality Agents interpret UI specifications obtained from the application and render them in a modality-appropriate fashion. They also serve as the initial point of contact for application initiated interactions.

The system enables pervasive access to applications beyond workflow systems and supports both push-based and pull-based interactions. While user interaction in current systems is based on a simple message-exchanges model, the system allows explicit handcrafting and customization of the UI, which enables more contextual information to be presented to the user and can result in a more friendly UI.

Further, the system enables access to Web applications from arbitrary collaboration modalities and offers the capability of application-initiated, two-way interactions.

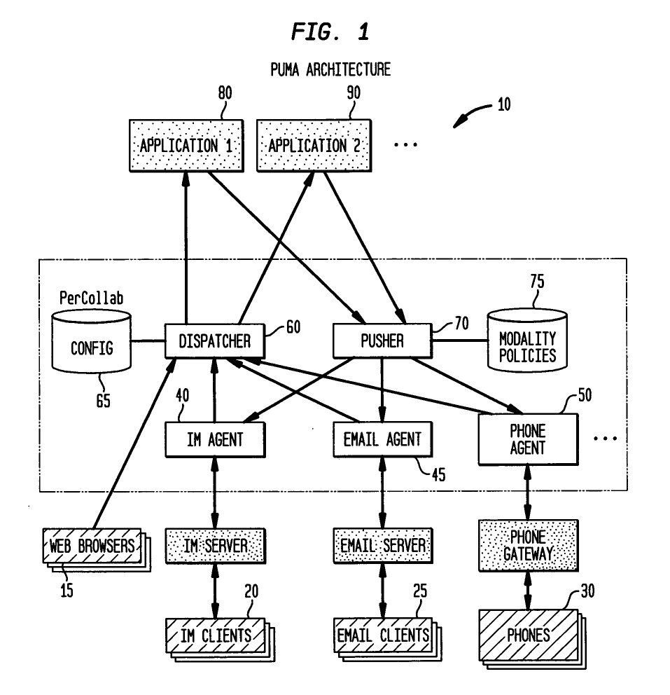

FIG. 1 depicts a system architecture 10 for implementing the present invention. In FIG. 1, the direction of arrows indicated in the figure describes the flow of control between components. The system accommodates a diverse and extensible set of clients, including conventional Web browsers 15, IM clients 20, e-mail clients 25, communications clients, e.g., PDAs, pagers, telephones or mobile/cell phones 30, and other collaboration devices. The collaboration devices and web-browsers are integrated into the system via Modality Agents such as IM Agent 40, Email Agent 45 and Phone Agent 50. Each Modality Agent connects one collaboration modality (e.g., IM, email and phone) and controls the user interactions through that particular modality. The Dispatcher 60 serves as a single point of entry for user requests from various clients, interprets those requests and routes them to corresponding applications 80, 90, based on navigation information contained in a configuration file 65. The Pusher component 70 handles application-initiated user interactions. It receives user interaction specifications 75 from applications and forwards them to appropriate Modality Agents 40, 45, 50 for the purpose of proactively engaging users via a callable client (i.e., a collaboration tool or device).

Modality Agents

The Modality Agents 40, 45, 50 allow disparate collaboration modalities to be integrated into the system 10. Each Modality Agent handles one category of collaboration tools and is addressable in the network of the corresponding modality. For example, the IM Modality Agent is a user in the instant messaging system. The user may start an instant messaging session with the Modality Agent and send it various messages. Similarly, the Phone Modality Agent may be reached at a standard telephone number. The user dials this number to use the system 10.

The Modality Agents 40, 45, 50 performs functions including 1) managing user interactions that go through collaboration tools of a particular type. The agent receives one view specification at a time and renders it in a modality-specific manner. Depending on the modality, the agent may or may not need to establish a connection with the collaboration tool before an interaction session starts; 2) the Modality Agent acts as a Web client and communicates with the Dispatcher. Each request from the Modality Agent is a bundling or composition of user input collected from the collaboration tool. The response from the application contains a new view specification. 3) the Modality Agent receives application-initiated interactions forwarded by the Pusher. It obtains an initial view specification through the Dispatcher so as to trigger an interaction with the user on his collaboration tool. It is possible that a Modality Agent may be conducting multiple interaction sessions with an end user at the same time. For example, one interaction may be initiated by the user, while another one is triggered by an application. Mingling messages from different interactions can be very confusing to the user. Depending on the modality, the agent can handle the situation in one of two ways: 1) the agent can tag each message with an interaction session ID or description so that the user can correlate messages properly, or 2) it can ban concurrent sessions altogether, requiring the user to suspend or exit one session in order to enter another.

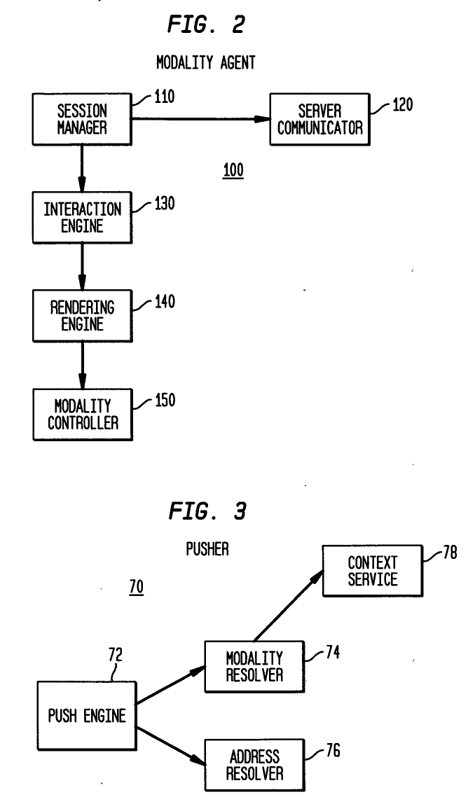

FIG. 2 depicts an architecture 100 for implementing modality agents according to one embodiment of the invention. In FIG. 2, the Session Manager 110 maintains all user interaction sessions. Each session object communicates with the application server via the Server Communicator component 120. The modality-independent view representation is handed off to the Interaction Engine 130, which extracts low-level presentation elements (e.g., labels and data) and interaction elements (e.g., type-in fields or selection lists) and passes them to the Rendering Engine 140 which is modality specific, and renders the presentation and interaction elements appropriately. The Rendering Engine 140 uses the Modality Controller 150 to communicate with a user's collaboration tool.

FIG. 3 depicts an architecture for implementing the Pusher 70 according to one embodiment of the invention. At the core of the Pusher 70 is the Push Engine 72 that receives and validates interaction specifications, determines the appropriate collaboration device for engaging the user by consulting with the Modality Resolver 74 and the Address Resolver 76, and delivers the interaction specifications to the corresponding Modality Agents.

The Modality Resolver 74 determines the proper modalities given a user ID and a modality policy ID. A modality policy may be predicated on temporal attributes (e.g., time of day) and the user's context conditions (connectivity, location, current activity, availability etc). In an extreme case, a modality policy can simply enumerate applicable modalities without a qualifying condition. One representation of the modality policies is to represent each policy as a set of rules. In this case, the Modality Resolver serves an interpreter of the policy rules. Another representation of the modality policies is to implement each policy as a Java class that implements all the policy logic. The Modality Resolver then instantiates and executes the Java object for the specified policy. The Context Service 78 is an infrastructure service for gathering and disseminating heterogeneous context information. A description of such a service may be found in the reference by H. Lei, D. Sow, J. Davis II, G. Banaduth and M. Ebling entitled “The Design and Applications of a Context Service” ACM Mobile Computing and Communications Review (MC2R), 6(4), October 2002, the context and disclosure of which is incorporated by reference herein. The system thus allows the Modality Resolver 74 to obtain user context information without having to worry about the details of context derivation and context management. Information currently provided by the Context Service includes IM online status, activities and contact means derived from calendar entries, desktop activities, as well as user locations reported from a variety of sources such as cellular providers, wireless LANs, GPS devices, and RIM blackberry devices.

The Address Resolver 76 returns the modality-specific address of a user, such as the user's telephone number or email address. Internally it uses a registry that maintains the mappings from user IDs to their modality-specific addresses.

User-Initiated Interaction

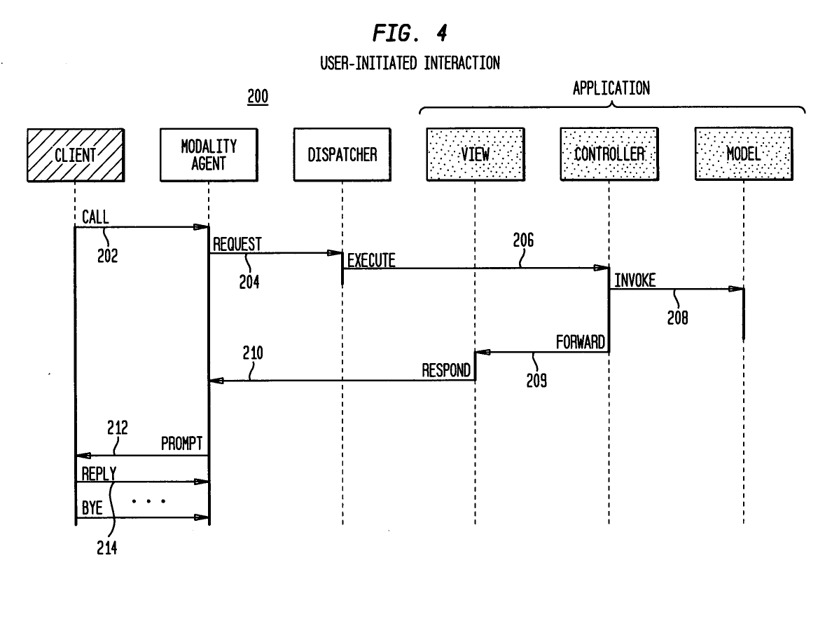

FIG. 4 provides an illustrative example of the sequence 200 of a user-initiated interaction according to one embodiment of the invention. In the example, it is assumed that the application is constructed based on the Model-View-Controller design pattern. In the example, the client is a connection-oriented collaboration mechanism such as a telephone or an IM client. Other clients work in a similar fashion. The interaction sequence 200 includes the following steps as shown in FIG. 4: Step 200—The user calls the Modality Agent from a collaboration client; Step 204—The Modality Agent sends a request to the Dispatcher, encoding the information that a user has called; Step 206—the Dispatcher delegates the request to the appropriate application by calling the application's Controller. Step 208—the Controller invokes the business logic by calling the Model component; Step 209—the Controller then forwards the control to an appropriate View component; Step 210—the View component generates the initial view markup and returns it to the Modality Agent; Step 212—the Modality Agent conducts a dialogue with the user according to the view markup; Step 214—if the view markup contains elements for user input, the Modality Agent bundles the user input in another request and repeats Steps 202 to 214 (not shown); and, the user leaves the call with the Modality Agent.

Application-Initiated Interaction

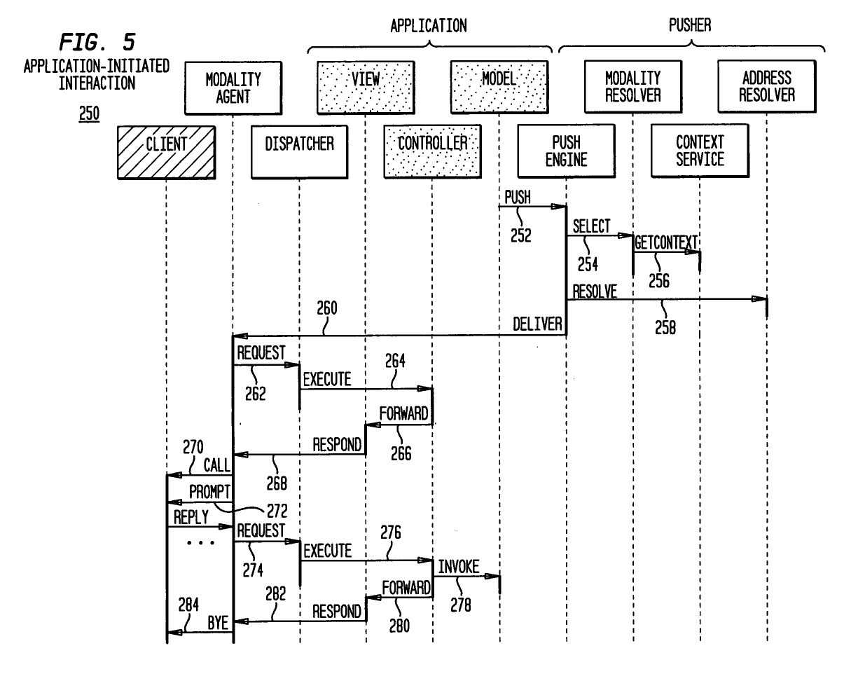

FIG. 5 provides an illustrative example of the sequence 250 of an application-initiated interaction according to one embodiment of the invention. It is assumed for exemplary purposes that the client is a connection-oriented collaboration mechanism. The interaction sequence 250 includes the following steps as shown in FIG. 5: Step 252—the business logic in the application sends an interaction descriptor to the Push Engine, along with the ID of the user that should be engaged, and the ID of the applicable modality selection policy. The interaction descriptor identifies the application itself and the interaction parameters; Step 254—the Push Engine calls the Modality Resolver to determine the appropriate modalities for the user; Step 256—the Modality Resolver optionally retrieves the user' current context information from the Context Service in its determination of proper modalities; Step 258—the Push Engine calls the Address Resolver to obtain the modality-specific addresses of the user; Step 260—the Push Engine delivers the interaction descriptor to the corresponding Modality Agents. It also passes to each Modality Agent the ID and the modality-specific address of the user. Each Modality Agent contacted then performs Steps 262 to 282 as follows: Step 262—the Modality Agent constructs a request based on the information received and sends the request to the Dispatcher; Step 264—the Dispatcher delegates the request to the appropriate application by calling the application's Controller; Step 266—the Controller then forwards the control to an appropriate View component; Step 268—the View component generates proper view markup, and returns the markup to the Modality Agent; Step 270—the Modality Agents calls the user in question to start a dialogue; Step 272—the Modality Agent conducts a dialogue with the user according to the view markup; Step 274—the Modality Agent bundles user input in another request and sends the request to the Dispatcher; Step 276—the Dispatcher again routes the request to the application's Controller; Step 278—the Controller invokes the business logic by calling the Model component. The Controller may also indicate to the application that the user has been engaged; Step 280—the Controller then forwards the control to an appropriate View component. Step 282—the View component generates the markup for the next view and returns the markup to the Modality Agent; Step 284—if the view markup indicates that no further user interaction is required, the Modality Agent ends the call. Otherwise, the Modality Agent repeats Steps 272 to 282 until either the user or the application terminates the interaction (not shown).

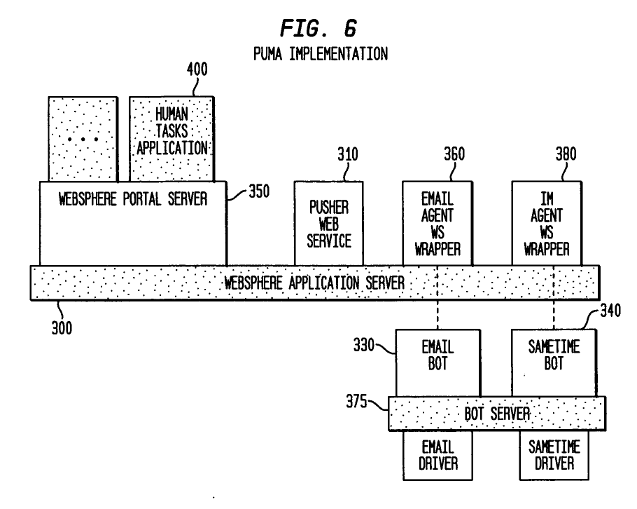

FIG. 6 depicts an example implementation of the invention. As shown in FIG. 6, the system is implemented on top of a WebSphere Application Server 300 (WAS) V5.0.1 available from International Business Machine's Inc. (IBM) (http://www-306. ibm.com/software/webservers/). A WebSphere Portal Server 350 (WPS) V5.0.1 also available from IBM (http://www-306.ibm.com/software/genservers/portal/) is employed as the Dispatcher, which itself installs as an enterprise application in WAS. WPS is chosen as the application platform because it naturally supports the MVC application model and heterogeneous client types. The Pusher is implemented as a Web service 310 in WAS. It consists of three sub-components: the Push Engine, the Modality Resolver and the Address Resolver. The APIs for the sub-components are given below:

Push Engine:
void push(InteractionDescriptor id, UserID user,
String modalityPolicyID);
Modality Resolver:
Modality[ ] select (String modalityPolicyID,
Address Resolver:
Address resolve(UserID user, Modality modality);

The push( ) method on the Push Engine is exposed in the Web service interface of the Pusher. Modality policies are represented as Java classes in our system, allowing flexible and expressive policies to be specified. Each modality policy class implements the following interface:

Interface ModalityPolicy {
public Modality[ ] select(UserID user);
}

Xforms (See Publication W3C^{•}“XForms—The Next Generation of Web Forms” at http://www.w3.org/Markup/Forms) may be used for the modality-independent representation of the View components of an application. Although XForms is a modality independent language, the view it represents does not have to be modality-independent. Using the WPS framework, an application developer can adapt a view to a particular modality by either supplying an XSLT stylesheet to tailor the layout and style of the view, or handcrafting a separate view for the modality. The modality-specific view, still encoded in XForms, can then be rendered by the corresponding Modality Agent.

The Modality Agents are implemented as bots on IBM's BotServer 375 which is a system that enables the creation and administration of intelligent action agents (i.e., bots) in various message-based environments. Each Modality Bot 330, 340 is wrapped in a respective Web service 360, 380 to facilitate the invocation by the Push Engine. The following method is exposed in the Web service interface of each Modality Agent:

void deliver(InteractionDescriptor id, UserID user,
Address clientAddress);

When a new interaction session requested by either a user or an application, is established with the user, the Modality Bot 375 creates a new session object and executes it on a thread taken from a pool of available threads. The session object issues an HTTP GET request to the WPS application and obtains the view to be rendered. The view is sent in XHTML with embedded XForms and is extracted from the application's response. The XForms data is then passed to the Interaction Engine (c.f. FIG. 2). The Interaction Engine builds upon the IBM XML Forms package (See IBM's XML Forms Package, April 2003 at http://www.alphaworks.ibm.com/tech/xmlforms). It loads the XForms, parses it, and calls various writers to process the XForms elements (e.g. input, output, select, switch). The writers are common across all modalities and use a modality specific Rendering Engine to actually present the elements. The writers populate the XForms instance data based on user input. They also perform schema validation and check for mandatory and relevant form fields before populating the instance data. When the form is to be submitted, the session object sends the instance data to the application server in an HTTP POST request along with the action. The application responds with the next view in the interaction sequence and the process repeats. The Rendering Engine for email batches all Xforms elements of a view. It sends a single email to the user at the end, prompting the user to fill in various input fields. The email is sent via the email communication driver, which is implemented using the JavaMail API (See description of Sun JavaMail at http://java.sun.com/products/javamail/). The session ID is embedded in the email body, in order for the Rendering Engine to correlate user replies. The input fields are also numbered for correlating user input with form fields. When the response is received, the data entered by the user are sent to the appropriate writers. The same user can be engaged in multiple sessions at the same time with the application.

The Rendering Engine for Sarnetime instant messaging is more interactive. It presents the Xforms elements as it receives them from the writers. User input is immediately sent to the writers in order to validate and update the instance data. In Sametime, since there is only one chat window for each correspondent, it would be confusing for the user to be engaged in multiple interaction sessions concurrently, as they would all be rendered in the single chat window with the Sametime Bot. Hence, only one session is allowed to be active. For example, if an application-triggered interaction occurs while the user is already in an active session, the Bot would inform the user about the new session and give the user an option to suspend or exit the current session and work on the new session. When an active session is finished, the user is presented with a menu of pending sessions to switch into.

In a non-limiting example implementation, the present invention is practiced to mobilize a particular application—a Human Tasks Application (HTA) 400 that has been developed by IBM. HTA supports the creation, management and processing of manual tasks. Such functionality is useful for many business integration solutions and business processes. The original HTA allows a task participant to perform the following operations from a Web browser: Query tasks: retrieve information on tasks assigned to this participant; Claim a task: gain exclusive ownership of a task (a task may have been assigned to multiple potential participants); Process a task: obtain corresponding task input data and provide task output data; Mark a task complete: declare completion of a task to prevent further editing of task output data; Unclaim a task: release the task and have it assigned to all potential participants again.

Although not shown, the HTA 400 comprises a Human Task Manager (HTM) service, the task list portlet, a collection of task processing portlets (one for each type of human tasks defined), and a collection of Java Server Pages (JSPs) (one for each portlet). The HTM is the Model part of the application, encapsulates the logic of human task man agement and maintains the state of human tasks. The portlets constitute the Controller part of the applications, and the JSPs serve as the View components.

The task list portlet basically queries the HTM for the user's tasks, and passes control to the corresponding JSP that generates the XForms for operating on the list of tasks. The XForms first shows a list of tasks available to the user and allows the selection of a task to work on. Once the task has been selected, it allows the user to claim, unclaim, process, and mark complete the selected task. If the user chooses to claim, unclaim, or mark complete the task, the requested action is performed by invoking the corresponding HTM API call and the user is returned back to the list of tasks. If the user chooses to process a task, the control is passed to the relevant task processing portlet. There is one task processing portlet for each task in the system. The task processing portlet interacts with the HTM to retrieve task state and data, bundles data into a Java bean, and passes control to the corresponding JSP that generates the Xforms markup. The Xforms layout may differ by tasks. However, in a typical case, the XForms first checks if the task has been claimed. If the task has not been claimed, the user is prompted to claim it. If the task is claimed, the XForms displays relevant task information to the user and prompts for user input if necessary. Finally, the user is given the option of completing the task, unless the task has the autocomplete feature turned on.

XForms have greater expressive power than traditional web forms and this ability is exploited to send a single XForms document with control flow embedded within the document. This allows the user interaction to take place via a disconnectable modality like email even when there is no network connectivity. The HTM was part of the original HTA. However, localized changes were made to have the HTM access the Pusher Web service and push new tasks to users. The original JSPs generate HTML markups but these are written to generate XForms instead. The portlets were also modified to call these new JSPs.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

1. A system for enabling modality-independent interaction between a web-based application and a user in web-based environment via a variety of client devices comprising:
a push means responsive to said application for initiating interaction with a user via a client device of a determined modality; and,
a modality agent means associated with said determined modality for enabling users to interact with said application via said client device.

2. The system as claimed in claim 1, further including: dispatcher means for receiving user-initiated inputs from a client device through intermediary of an associated modality agent, and forwarding the request to the application.

3. The system as claimed in claim 2, further including: a configuration file comprising navigation information, said dispatcher means forwarding a user initiated request to an application based on the stored navigation information.

4. The system as claimed in claim 1, wherein said push means comprises:
means for receiving input interaction specifications for enabling interaction with said application;
means for determining a client device for interacting with a user; and,
means for delivering said interaction specifications to a corresponding modality agent means based on the determined client device.

5. The system as claimed in claim 4, wherein said input interaction specifications include a user ID, said determining means for determining a proper modality for engaging a user based on said user ID.

6. The system as claimed in claim 4, wherein said input interaction specifications include a modality selection policy ID, said determining means for determining a proper modality for engaging a user based on said modality selection policy.

7. The system as claimed in claim 6, wherein said modality selection policy is based on user context information.

8. The system as claimed in claim 7, further comprising a context service infrastructure for gathering, maintaining and disseminating said user context information.

9. The system as claimed in claim 4, wherein said determining means comprises: means for determining a modality-specific address of a user, to proactively engage a user via that user's determined client device.

10. The system as claimed in claim 4, wherein said modality agent comprises a web-based client in communication with said dispatcher means, said modality agent forwarding user input collected from a client device to said dispatcher means.

11. The system as claimed in claim 1, wherein said modality agent means comprises means for managing user interaction sessions through said modality agent means.

12. The system as claimed in claim 1, wherein said modality agent means receives a modality-independent representation of an application view, said modality agent means comprising a means for extracting presentation elements and interaction elements from said modality-independent representation and rendering said presentation and interaction elements in a modality specific manner for a user's client device.

13. The system as claimed in claim 11, wherein said modality-independent representation of the application view is an Xforms representation.

14. The system as claimed in claim 1, wherein a modality agent includes a collaboration mechanism for a client device of a modality selected from the group comprising: Instant Messaging, Short Message Service, e-mail, telephone, cell phone, personal digital assistant, pager device, or mobile communications device.

15. A method for enabling modality-independent interaction between a web-based application and a user in web-based environment via a variety of client devices comprising:
providing a push means for enabling application-initiated interaction with a user via a client device of a determined modality; and,
providing a modality agent means associated with said determined modality for enabling users to interact with said application via said client device.

16. The method as claimed in claim 15, further including: implementing dispatcher means for receiving user-initiated inputs from a client device through intermediary of an associated modality agent, and forwarding the request to the application.

17. The method as claimed in claim 16, further including: referring to a configuration file comprising navigation information, wherein said forwarding a user initiated request to a application is based on the stored navigation information.

18. The method as claimed in claim 15, wherein said enabling application-initiated interactions comprises:
receiving input interaction specifications for interacting with said application;
determining a client device for interacting with a user; and,
delivering interaction specifications to a corresponding modality agent means based on the determined client device.

19. The method as claimed in claim 18, wherein said input interaction specifications include a user ID, said determining comprising determining a proper modality for engaging a user based on said user ID.

20. The method as claimed in claim 18, wherein said input interaction specifications include a modality selection policy ID, said determining comprising determining a proper modality for engaging a user based on said modality selection policy.

21. The method as claimed in claim 20, wherein said modality selection policy is based on user context information.

22. The method as claimed in claim 21, further comprising: gathering, maintaining and disseminating said user context information for said determining means.

23. The method as claimed in claim 18, further comprising: determining a modality-specific address of a user, to proactively engage a user via that user's determined client device.

24. The method as claimed in claim 18, wherein said modality agent comprises a web-based client in communication with said dispatcher means, said modality agent forwarding user input collected from a client device to said dispatcher means.

25. The method as claimed in claim 15, further comprising: managing user interaction sessions through said modality agent means.

26. The method as claimed in claim 15, further comprising: receiving a modality-independent representation of an application view, said modality agent means extracting presentation elements and interaction elements from said modality-independent representation and rendering said presentation and interaction elements in a modality specific manner for a user's client device.

27. The method as claimed in claim 26, wherein said modality-independent representation of the application view is an Xforms representation.

28. The method as claimed in claim 15, wherein a modality agent includes a collaboration mechanism for a collaboration client device of a modality selected from the group comprising: Instant Messaging, Short Message Service, e-mail, telephone, pager device, cell phone or mobile phone.

29. A computer program product comprising a computer usable medium having a computer usable program code enabling modality-independent interaction between a web-based application and a user in web-based environment via a variety of client devices, said computer program product comprising:
computer readable program code for enabling application-initiated interaction with a user via a client device of a determined modality;
computer readable program code functioning as a modality agent associated with said determined modality for enabling users to interact with said application via said client device.
